(19) United States
(12) Patent Application Publication
(10) Pub. No.: US 2010/0018216 A1
(43) Pub. Date: Jan. 28, 2010

(54) Carbon capture compliant polygeneration

(76) Inventor: Alexander G. Fassbender, Arlington, VA (US)

Correspondence Address: Kyla D. Aycock;Speed Law Firm, Suite 1200, 111 Center Street, Little Rock, AR, 72201, US

(21) Appl. No.: 12/381,881

(22) Filed: Mar. 17, 2009

Related U.S. Application Data
(60) Provisional application No. 61/070,032, filed on Mar. 17, 2008.
(60) Provisional application No. 61/134,469, filed on Jul. 10, 2008.

(51) Int. Cl. F02C 6/00; C10J 3/46

(52) U.S. Cl. 60/780; 48/197 R

(57) ABSTRACT

Embodiments include a method and apparatus for producing liquid fuel from a carbon-containing feed fuel such as coal. With embodiments, coal or other carbon-containing feed fuel may be utilized to produce co-products, including one or more liquid fuels, power, and/or other useful co-products, while capturing carbon dioxide for further use, storage, and/or sequestration.

### CROSS-REFERENCE TO RELATED APPLICATIONS

This application claims benefit of U.S. provisional patent application Ser. No. 61/070,032, filed Mar. 17, 2008 and entitled “Compliant Polygeneration,” which is herein incorporated by reference. This application also claims benefit of U.S. provisional patent application Ser. No. 61/134,469, filed Jul. 10, 2008 and also entitled “Compliant Polygeneration,” which is herein incorporated by reference.

### BACKGROUND OF THE INVENTION

1. Field of the Invention

Embodiments generally relate to a coal (or other carbon source, lignite, and/or domestic energy source such as biomass) to liquids system and process.

2. Description of the Related Art

The United States economy consumes energy in the forms of electricity, heat for buildings, heat and feedstock for industrial processes, and in transportation fuel. At present, crude oil or petroleum provides about 40 percent of energy consumed in the United States, more than any other source. Almost all U.S. transportation energy is derived from petroleum, including natural gas petroleum liquids (“NGPL”). More than 60 percent of petroleum is imported, and it is primarily used for transportation purposes. Some of the countries from which the petroleum is imported lack democratic forms of government, may be unstable, or have taken positions that may be unfriendly to the U.S. interests. Additionally, the price of petroleum is very volatile and is increasing. It would therefore be beneficial to reduce the country's dependence on importing petroleum from other countries to increase economic stability and enhance national security.

Coal is the largest fossil fuel reserve in the U.S., with an estimated at least 200-250 years of supply existing at current usage rates. There has therefore been much interest in using coal and biomass to produce synthetic petroleum products and chemicals because coal is less expensive and less subject to price volatility than crude oil. Coal has the potential to offer to the electricity-generating industry an alternative source of power production with stable pricing, a revenue stream from petroleum liquids production, the potential for lower greenhouse gas emissions, and an opportunity to increase efficiency of electricity generating plants.

Attempts have been made to produce liquid fuel, e.g., for use as transportation fuel, from coal. An undesirable by-product of current methods of liquid fuel production from coal is carbon dioxide (CO₂) emissions. Some current methods of producing liquid fuel from coal are inadequate because they require the use of costly and inefficient steps to capture and compress the carbon dioxide associated with the process.

Carbon dioxide emissions are detrimental to the environment, as carbon dioxide is a harmful greenhouse gas. To make the conversion of coal to an alternative liquid fuel acceptable, the environmental impact of the lifecycle greenhouse gas emissions associated with the production and combustion of the coal should be less than or equal to the emissions from equivalent conventional fuel produced from conventional petroleum sources. In fact, these emissions requirements are delineated in Section 526 of the Energy Independence and Security Act entitled “Procurement and Acquisition of Alternative Fuels,” which prohibits federal agencies from entering into a contract for procurement of an alternative or synthetic fuel if these emissions requirements are not achieved. The combined production of electricity and synthesis gas derived fuels or chemicals is generally referred to as polygeneration. Polygeneration of electric power and other synthesis gas derived products where the life cycle carbon dioxide emissions from those synthesis gas derived products is less than or equal to the life cycle carbon dioxide emissions from those same products derived from crude oil is herein referred to as carbon capture compliant polygeneration.

If a substantial portion, e.g., approximately 75 percent to approximately 90 percent, of the carbon dioxide produced in coal-to-liquid fuel production is removed and disposed of in an environmentally-friendly way (such as further use, storage, or sequestration), the lifecycle carbon emissions of coal-to-liquid production may be lowered to about the same levels as those from conventional petroleum-based fuels. Carbon sequestration, which is also referred to as carbon capture and storage (“CCS”), includes separating, compressing, and transporting carbon dioxide to an appropriate geologic formation, where it is injected and stored permanently underground.

Decreasing carbon dioxide emissions from coal-to-liquid fuel production is therefore desirable to decrease impact on the environment to allow the conversion of coal into a viable petroleum substitute. To decrease carbon dioxide emissions, any viable coal-to-liquids plant must separate carbon dioxide from other gas streams for disposal of the carbon dioxide via carbon sequestration or other carbon dioxide disposal methods.

Capturing carbon dioxide is one of the largest cost components in the capture and sequestration process in coal-based facilities. It is desirable to decrease the cost of and increase the efficiency of capturing carbon dioxide in coal-to-liquid production.

### SUMMARY OF THE INVENTION

Therefore, it is an object of embodiments to provide a compliant polygeneration system and process with carbon capture of approximately 90 percent or more which is cost-effective and efficient.

It is a further object of embodiments to provide a compliant polygeneration system and process which releases minimal acid gas or toxic emissions into the atmosphere.

It is yet a further object of embodiments to provide an uncomplicated compliant polygeneration system and process having a reduced number of process steps.

It is also an object of embodiments to provide an efficient compliant polygeneration system and process, minimizing capital and operating cost and maximizing co-production of products from coal or other carbon-based feed stocks.

It is further an object of embodiments to provide a carbon capture compliant polygeneration system and process in which the fuel source is flexible to include many or all types of coal as well as other domestic energy sources.

To this end, embodiments include a method of co-producing one or more liquid fuel or chemical products and an electrical power product using a carbon-containing feed fuel, comprising providing an air separation unit to separate oxygen from air; gasifying the feed fuel with the separated oxygen to produce a syngas; removing hydrogen sulfide from the syngas using a Rectisol or Selexol process, thereby forming a Rectisol or Selexol product stream; performing Fischer-Tropsch synthesis on the Rectisol or Selexol product stream to produce the one or more liquid fuel or chemical products; separating the produced fuels or chemical products from a tailgas; combusting the tailgas using pressurized oxyfuel combustion to form the electrical power product; and capturing pressurized carbon dioxide from the products of the tailgas combustion.

Embodiments may also generally include a method of forming one or more liquid co-products from a carbon-containing feed fuel, comprising separating oxygen from air using an air separation unit to form liquid oxygen; pressurizing the liquid oxygen; gasifying the feed fuel to form a syngas; performing a Rectisol or Selexol process on the syngas using a solvent to remove acid gas from the syngas, thereby forming a carbon dioxide rich product stream; and using at least a portion of the liquid oxygen in the Rectisol or Selexol process for temperature control of the solvent.

Other and further embodiments may include a method of producing one or more liquid fuel products and capturing carbon dioxide from a carbon-containing feed fuel, comprising performing a gasification of the feed fuel, thereby producing a syngas; cleaning the syngas by removing gases and contaminants; passing the cleaned syngas into a Fischer-Tropsch reactor to form the one or more liquid fuel products and separate a carbon dioxide rich tailgas from the syngas; passing the carbon dioxide rich tailgas into a combustion chamber at a first pressure substantially within a range of approximately 700 psia to approximately 2000 psia; passing an oxidant into the combustion chamber at a first pressure substantially within a range of approximately 700 psia to approximately 2000 psia; oxidizing the tailgas in the combustion chamber at a first pressure substantially within a range of approximately 700 psia to approximately 2000 psia; passing a coolant into the combustion chamber in a heat exchange relationship with the tailgas and oxidant; and capturing the carbon dioxide from the carbon dioxide rich tailgas.

### BRIEF DESCRIPTION OF THE DRAWINGS

So that the manner in which the above-recited features of embodiments of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic representation of a first embodiment of a compliant polygeneration with co-production system and process.

FIG. 2 is a schematic representation of a second embodiment of a compliant polygeneration with co-production system and process.

FIG. 3 is a schematic representation of a third embodiment of a compliant polygeneration with co-production system and process.

FIG. 4 is a schematic representation of a Fischer-Tropsch tailgas plant steam cycle according to embodiments.

FIG. 5 is a schematic representation of a Fischer-Tropsch (“FT”) tailgas combustion cycle according to embodiments.

FIG. 6 is a side view of a multi-tubular (ARGE) fixed bed FT reactor.

FIG. 7 is a side view of a circulating (synthol) fluidized bed FT reactor.

FIG. 8 is a side view of a fixed (sasol advanced synthol) fluidized bed FT reactor.

FIG. 9 is a side view of a fixed slurry bed FT reactor.

FIG. 10 is an illustration of chain initiation in an FT chain building process.

FIG. 11 is an illustration of an FT chain building process.

FIG. 12 is a graph showing a first example of a product distribution in an FT reactor with an iron catalyst.

FIG. 13 is a graph showing a second example of a product distribution in an FT reactor with a cobalt catalyst.

### DETAILED DESCRIPTION

Embodiments of the present invention use coal (and/or other domestic energy or carbon-containing source) gasification with co-production to reduce the overall environmental footprint associated with power and fuel production from coal (or other domestic energy source) compared to that of conventional technologies for generating electricity and liquid fuels. Carbon dioxide is also effectively, efficiently, and inexpensively removed from the feed F.

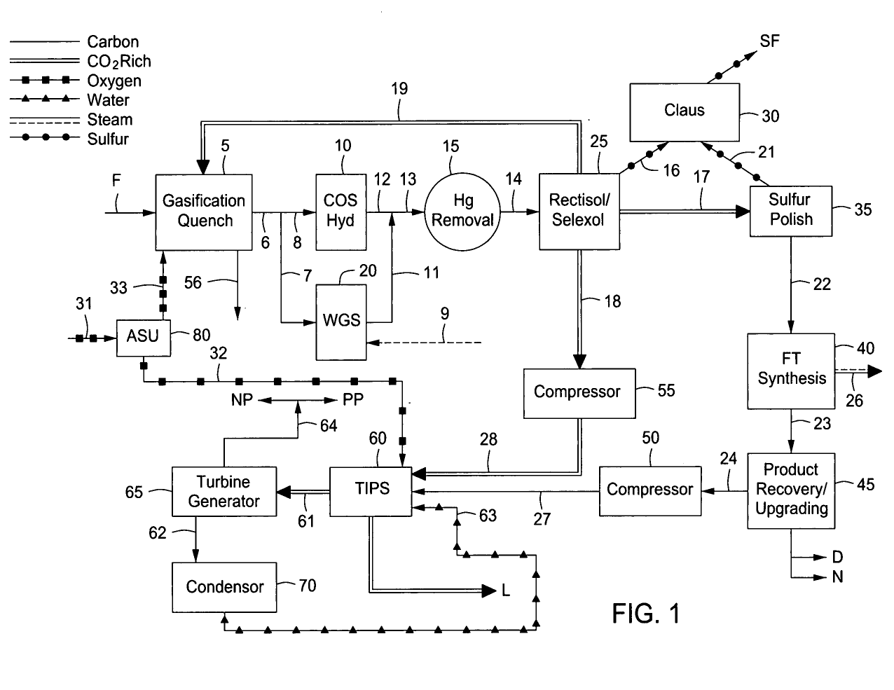

An embodiment of coal (and/or other domestic energy or carbon-containing source such as lignite, biomass, petcoke, coke, refuse, biofuels, natural gas, emulsion, and/or bitumen) gasification with co-production process is shown in FIG. 1. Coal gasification with co-production is the gasification of coal and/or optionally other domestic energy or carbon-based sources, to produce electricity, transportation fuels, chemicals, fertilizer, pipeline-quality synthetic gas, and/or other products (co-products). The conversion of coal and other low cost fuels to form desirable co-products such as transportation fuels (e.g., diesel), naphtha, and electricity is of interest to reduce this nation's dependence on foreign fuel sources by using coal, which is more prevalent than other fuel sources in the U.S. The ability to convert coal, a domestic resource, to a natural gas substitute and a predictable, stable, and economic source of transportation fuel that is less expensive and less subject to price volatility is beneficial.

Previous processes for producing useful liquid products from coal such as transportation fuels produce increased emissions of harmful carbon dioxide, which is the primary greenhouse gas. Many states are increasingly regulating the amount of carbon dioxide emissions allowed in these types of processes. Therefore, costly carbon dioxide separation has previously been the only option, decreasing or eliminating economic viability of coal-to-liquids prior processes.

Coal gasification with co-production using the Fischer-Tropsch (“FT”) process (see below) is attractive because carbon dioxide separation from the other gas streams is inherent to FT co-production plants, lowering the cost for carbon separation or sequestration relative to other fossil-based projects. (In other types of fossil-based projects, carbon dioxide must be separated in an additional process to the power production from coal, thereby adding to the cost of the entire process.) Previous coal-to-liquids processes typically use a combined cycle technology where the carbon dioxide and carbon contained in the tail gas entering the power block are released to the atmosphere. (Carbon dioxide is a greenhouse gas and is already subject to regulation in the United States and other countries.)

Embodiments of the process of FIG. 1 add ThermoEnergy Integrated Power System™ (“TIPS”) technology, as disclosed in U.S. Pat. Nos. 6,196,000 and 6,918,253, both patents incorporated by reference herein in their entirety into the subject process. The TIPS technology is used for combustion of the tailgas in the power block, producing a pipeline quality liquid carbon dioxide product. One or more tailgas compressors may be added to compress the tailgas stream exiting product recovery/upgrading, and the compressed tailgas enters a TIPS boiler for treatment. An oxidant such as oxygen from one or more air separation units (“ASUs”) may be used in the TIPS boiler, and carbon dioxide from a carbon dioxide rich stream exiting an acid gas removal system such as a Rectisol or Selexol unit, after compression, may be used in the TIPS boiler for temperature control. The TIPS boiler then outputs the pipeline quality liquid product and power.

The coal to liquid with TIPS process shown in FIG. 1 includes a gasification process (quench gasifier with one or more gasifier trains), a Rectisol or Selexol process, Fischer-Tropsch synthesis (“FT synthesis”), and TIPS. Coal gasification converts the hydrocarbons in coal into “syngas,” a gas rich in carbon monoxide and hydrogen. Carbon dioxide, sulfur, mercury, slag, and other by-products of gasification are amenable to capture, collection, and reuse (or possibly sequestration in the case of carbon dioxide), and undesirable nitrogen oxides are produced only at low levels. The syngas is then cleaned and converted in various chemical processes to any of a range of chemical outputs. For example, an FT system or unit may covert the syngas to ultra-clean transportation fuels and/or to methanol, dimethyl ether, hydrogen, or ammonia-based fertilizer.

The Rectisol and Selexol processes are acid gas removal processes that separate acid gases such as hydrogen sulfide and carbon dioxide from valuable feed gas streams. The Rectisol process uses methanol as a solvent to separate the acid gases from the feed gas streams, and the methanol is able to remove trace contaminants such as ammonia found in these gases also. The Selexol process uses an amine-based Selexol solvent to absorb the acid gases from the feed gas at relatively high pressure. Regardless of whether the process is Rectisol or Selexol, the shown Claus plant or unit may optionally be utilized to convert resulting hydrogen sulfide to elemental sulfur. Of course, other comparable plants, units, or processes capable of converting hydrogen sulfide to elemental sulfur may be utilized in lieu of or in addition to the Claus unit, and multiple Claus units or plants may be used in some embodiments.

The Fischer-Tropsch process (FT process) is a catalyzed chemical reaction in which the syngas (synthesis gas) resulting from the coal gasification is converted into liquid hydrocarbons or fuels of various forms, including possibly alkanes, alkenes waxes and related chemicals. The FT process may for example catalytically convert the syngas exiting from the gasifier into a wax and refine the wax to produce FT fuels for transportation, such as FT diesel or FT jet or aviation fuel, plus naphtha. Common catalysts used in the FT process are iron, cobalt, nickel and ruthenium. The principal purpose of the FT process is to product a synthetic petroleum substitute from coal.

Carbon dioxide rich and hydrogen sulfide rich streams are produced from the Rectisol or Selexol process. The FT synthesis and product recovery process also produces a carbon dioxide rich tail-gas stream. This tail-gas stream may then be treated in the TIPS boiler to reduce carbon dioxide emissions and form a pipeline quality liquid product by integrating the TIPS unit in coal to liquid co-production. This is accomplished by removing the carbon dioxide removal step and the gas turbine based power block of a typical coal to liquids process and adding the TIPS process. In addition to reducing carbon dioxide emissions and increasing carbon capture, this method reduces the risk that a Selective Catalytic Reduction (“SCR”) requirement might be imposed on the combined cycle power block (by having the TIPS technology handle the power block energy production, as further described in paragraph [0078]), reduces cost, and simplifies the overall flow sheet.

Within this description previously and hereafter, coal as an energy source is interchangeable with other carbon-based or carbon-containing energy sources or solid feed fuels or fossil fuels, for example biomass, petcoke, fuel, refuse, biofuel, natural gas, emulsion, lignite, coke, heavy hydrocarbons, tires, and/or bitumen. Coal is also interchangeable with hydrocarbon-containing, carbonaceous, and/or hydrocarbonaceous fuel. FIG. 1 shows an embodiment of a coal gasification with co-production system and process, which may include a coal-to-liquid system and process with TIPS. In this system and process, gasification of coal and other domestic energy sources, including biomass, is used to produce electricity, transportation fuels such as diesel fuels, chemicals, fertilizer, pipeline-quality synthetic gas, and/or other products. Feed F is ultimately converted into several usable and valuable products, including Fischer-Tropsch fuels such as diesel D and naphtha N, clean water, sulfur SF, net power NP, and/or plant power PP or electricity. By producing various usable and valuable products, co-production is important to several industries, including nitrogen fertilizer, sulfur chemicals, liquid transportation fuels and chemicals, which currently rely on oil or natural gas as an energy source and/or feedstock. Pipeline quality liquid product L, slag SL, mercury, and other contaminants are separatable from these valuable and useful products in embodiments of the system and process.

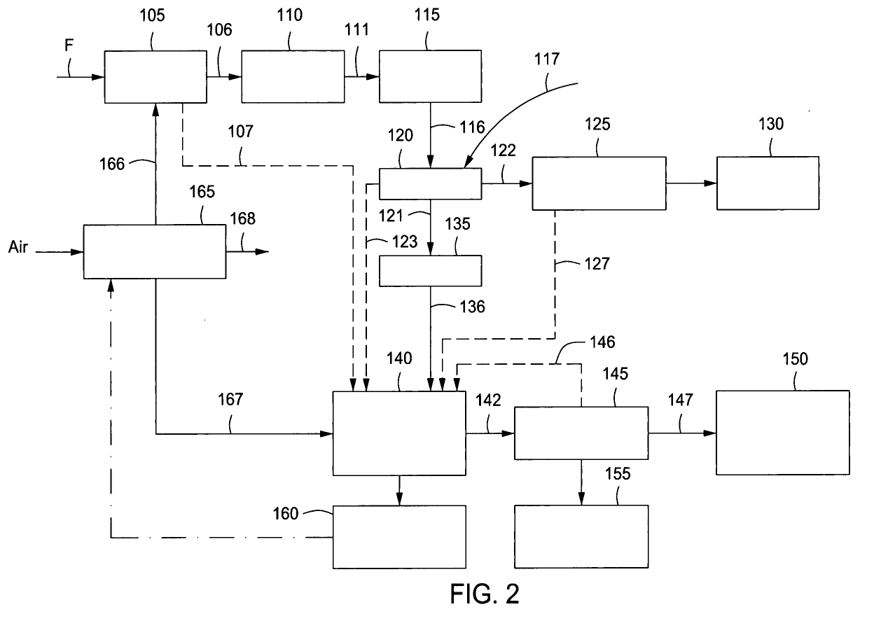

The feed F may include one or more of the following energy sources: one or more carbon sources, bituminous coal, sub-bituminous coal, anthracite coal, lignite, petcoke, refuse, tires, coke, natural gas, wood, emulsion, bitumen, hydrocarbon-containing fuel, carbonaceous fuel, carbon-containing fuel, hydrocarbonaceous fuel, liquid methanol gas, and/or domestic energy sources such as biomass (these possible feed fuels also apply to the embodiments of FIGS. 2-5). The feed F may include coal, for example, as shown in the process of FIG. 1. In one exemplary embodiment, the feed F may include approximately 4,891 tons per day (TPD) of coal, including approximately 3,118 TPD carbon. This example embodiment mass balance is referred to throughout the description and is merely exemplary. Other mass flow rates are within the scope of embodiments.

Co-production includes gasifying input feed F to produce a syngas and by-products, including carbon dioxide. Broadly, the feed F is gasified with a quench gasifier 5, placed through a Rectisol or Selexol process 25, enters an FT process or synthesis 40, and proceeds through a TIPS boiler 60. Ultimately, co-production products include electric power generation, FT liquid synthesis to form transportation fuel such as diesel and jet fuel, pipeline-quality gas, naphtha, sulfur, ammonia which may be used to make fertilizer, methanol, dimethyl ether, water, and/or hydrogen.

The quench gasifier 5 may include one or more gasifier trains, in some embodiments two gasifier trains. The quench gasifier 5 gasifies the feed F to form a synthesis gas (“syngas”) 6 and slag SL product. Gasification operates at high temperatures and with oxygen and steam to chemically convert the feed F to a syngas 6. After gasification, the syngas may be cleaned of particulates and other contaminants such as mercury, sulfur, ammonia, chlorides, and carbon dioxide. Carbon dioxide, sulfur, mercury, slag, and other by-products of gasification are capable of capture, collection, reuse, and/or sequestration, and nitrogen oxides are produced only at low levels. The slag SL product may include 31 TPD of carbon in the exemplary embodiment.

The product syngas 6 includes carbon monoxide (CO) gas and hydrogen (H₂) gas. The syngas 6 may be used in many ways, including serving as a feedstock for a range of chemical processes and providing power to other processes to produce electricity. A carbon monoxide gas portion 7 of the syngas 6 optionally may detour into a water-gas shift reaction (“WGS reaction”) 20. The WGS reaction 20 changes the hydrogen-to-carbon ratio of the syngas 6 by reacting the carbon monoxide in the syngas 6 with water to produce carbon dioxide and additional hydrogen in stream 11. Optionally, steam 9 is fed into the WGS reaction 20. The WGS reaction is a chemical reaction that converts the carbon monoxide gas portion 7 of the syngas 6 into the gas stream 11 including carbon dioxide (CO₂) and hydrogen (H₂) gas using water via the following reaction:

CO+H₂O→CO₂+H₂

The remainder of the syngas 8 may be flowed into a carbonyl sulfide (COS) hydrolysis unit 10 and exits the COS hydrolysis unit 10 as product stream 12. The COS hydrolysis unit 10 converts most of the COS to hydrogen sulfide (H₂S). The product stream 12 is optionally combined with the gas stream 11 from the WGS reaction 20 into stream 13, which stream 13 enters a mercury (Hg) removal stage(s), process(es), or unit(s) 15, which operates to remove the mercury from the stream 13. The mercury removal unit 15 may be, for example, one or more activated carbon absorbers, or any other mercury removal unit(s), system(s), or process(es) known to those skilled in the art. Stream 14 exits the Hg removal unit 15 to enter the Rectisol or Selexol process 25, described in more detail below.

A Rectisol or Selexol process 25 is an acid gas removal process for separating acid gases such as hydrogen sulfide and carbon dioxide from valuable feed streams. Rectisol is an acid gas removal process that uses methanol as a solvent to separate acid gases such as hydrogen sulfide and carbon dioxide from the valuable feed gas streams. By doing so, the feed gas is made more suitable for combustion and/or further processing. Rectisol may be utilized to treat the syngas produced by gasification of coal or heavy hydrocarbons, as the methanol solvent is well able to remove trace contaminants such as hydrogen sulfide and ammonia usually found in these gases.

In the Rectisol process, cold methanol at approximately 40° F. (−40° C.) dissolves (absorbs) the acid gases from the feed gas at relatively high pressure, usually approximately 400 psia to approximately 1000 psia (approximately 2.76 MPa to approximately 6.89 MPa). The rich solvent containing the acid gases is then let down in pressure and/or steam stripped to release and recover the acid gases. The Rectisol process may operate selectively to recover hydrogen sulfide and carbon dioxide as separate streams, so that the hydrogen sulfide can be sent to one or more optional Claus units for conversion to elemental sulfur.

Rectisol, like Selexol, is a physical solvent, unlike amine based acid gas removal solvents that rely on a chemical reaction with the acid gases. While the methanol solvent is inexpensive compared to the proprietary Selexol solvent, the Rectisol process requires refrigeration to maintain the low temperatures needed to absorb the acid gases.

Selexol is an acid gas removal solvent that can separate acid gases such as hydrogen sulfide and carbon dioxide from feed gas streams such as syngas produced by gasification of coal, coke, and/or heavy hydrocarbon oils. By doing so, the feed gas is made more suitable for combustion and/or further processing.

In the Selexol process, the Selexol solvent dissolves (absorbs) the acid gases from the feed gas at relatively high pressure, usually approximately 300 psia to approximately 2000 psia (approximately 2.07 MPa to approximately 13.8 MPa). The rich solvent containing the acid gases is then let down in pressure and/or steam stripped to release and recover the acid gases. The Selexol process can operate selectively to recover hydrogen sulfide and carbon dioxide as separate streams, so that the hydrogen sulfide can optionally be sent to one or more Claus units for conversion to elemental sulfur. The Selexol process is similar to the Rectisol process, but the Selexol solvent is a mixture of the dimethyl ethers of polyethylene glycol.

Selexol is a physical solvent, unlike amine based acid gas removal solvents that rely on a chemical reaction with the acid gases. Since no chemical reactions are involved, Selexol usually requires less energy than the amine based processes. However, at feed gas pressures below about 300 psia (approximately 2.07 MPa), the Selexol solvent capacity (in amount of acid gas absorbed per volume of solvent) may be reduced.

The Rectisol process may achieve lower sulfur content in its product than the Selexol process. This lower sulfur content is desirable because it is important to remove sulfur from the feed stream into the FT system/unit for effective FT synthesis. As mentioned previously, in the Rectisol process, a temperature of approximately 40° F. for the methanol solvent should be achieved to produce the desired separation.

The Rectisol or Selexol process 25 produces a hydrogen sulfide (H₂S) containing stream 16, as well as one or more carbon dioxide rich streams. In the embodiment shown in FIG. 1, the carbon dioxide rich product from the Rectisol or Selexol process 25 is split into three streams, specifically carbon dioxide rich streams 17, 18, and 19. As mentioned previously, one or more Claus units or plants 30 with optional tailgas cleanup may be used in conjunction with the Rectisol or Selexol process 25 to convert the hydrogen sulfide gas containing stream 16 into elemental sulfur SF and recover the sulfur product. The Claus unit or plant is known to those skilled in art and operates as such.

The carbon dioxide rich streams 17, 18, 19 may be directed to three different uses in the process. In some embodiments, the carbon dioxide rich gas stream 19 is optionally recycled to the quench gasifier 5 as an injection gas. Of course, it is within the scope of alternate embodiments that the recycled carbon dioxide rich stream 19 is eliminated. In the embodiments where the carbon dioxide rich gas stream 19 is recycled to the quench gasifier as shown in FIG. 1, an exemplary amount of carbon within the carbon dioxide rich stream 19 which is in line with previous examples is 200 TPD carbon.

In some embodiments, the carbon-dioxide rich stream 17 is ultimately sent to the FT process or synthesis 40 (described in more detail below). Optionally, carbon dioxide rich stream 17 may enter a sulfur polish 35 prior to flowing into the FT process 40 to remove more of the sulfur from the carbon dioxide rich stream 17. This additional sulfur-containing stream 21 exits the sulfur polish 35 and may be flowed into the Claus plant 30 for conversion into elemental sulfur SF and combined with the elemental sulfur produced from stream 16. The Claus plant or unit 30 may optionally include tail gas cleanup. A carbon rich stream 22 may flow from the sulfur polish 35 into the FT process 40.

The FT process 40 catalytically converts the syngas into one or more hydrocarbons including wax and refines the wax to produce FT fuels for transportation, such as FT diesel or FT jet fuel, plus naphtha. Generally, the FT process 40 converts the syngas from the gasification into liquid fuels, such as FT diesel or FT aviation fuel, and naphtha. Below is a general description of the FT process 40.

Two main characteristics of FT synthesis are the unavoidable production of a wide range of hydrocarbon products (olefins, paraffins, and oxygenated products) and the liberation of a large amount of heat from the highly exothermic synthesis reactions.

The FT process includes the use of alkalized iron catalysts to produce liquid hydrocarbons rich in oxygenated compounds, termed the Synthol process. The FT synthesis is in principle a carbon chain building process, where CH₂ groups are attached to the carbon chain. The resulting overall reaction may be illustrated as follows:

$$n CO + ( n + \frac{m}{2} ) {H}_{2} -> {C}_{n} {H}_{m} + {n H}_{2} O$$

$$CO + 2 {H}_{2} -> - {CH}_{2} - + {H}_{2} O$$

$$Δ {H}_{FT}^{o} = - 165 kJ \text{/} mol$$

There are also other reactions taking place in the reactor. Some reactions reported are:

TABLE 7
Reactions taking place in the FT reactor [37]

| | Reaction enthalpy: |
|---|---|
| Reaction: | ΔH_{300 K} [kJ/mol] |
| CO + 2H₂ → —CH₂— + H₂O | −165.0 |
| 2 CO + H₂ → —CH₂— + CO₂ | −204.7 |
| CO + H₂O → H₂ + CO₂ | −39.8 |
| 3CO + H₂ → —CH₂— + 2CO₂ | −244.5 |
| CO₂ + 3 H₂ → —CH₂— + 2H₂O | −125.2 |

These reactions are highly exothermic, and to avoid an increase in temperature, which results in lighter hydrocarbons, it is important to have sufficient cooling to secure stable reaction conditions. The total heat of reaction may amount to approximately 25% of the heat of combustion of the synthesis gas.

The reaction is dependent of a catalyst, typically an iron or cobalt catalyst where the reaction takes place. There is either a low or high temperature process (LTFT, HTFT), with temperatures ranging between approximately 200-240° C. for LTFT and approximately 300-350° C. for HTFT. The HTFT may use an iron catalyst, and the LTFT may use either an iron or a cobalt catalyst. The different catalysts also include nickel and ruthenium (Ru) based catalysts, which also have enough activity for commercial use of FT. But the availability of Ru is often limited, thus forcing a high price. The nickel based catalyst has high activity but usually produces too much methane, and additionally the performance at high pressure is usually poor due to production of volatile carbonyls, so that only cobalt and iron may be practical catalysts. Iron is cheap, but cobalt has the advantage of higher activity and longer life, though it is on a metal basis 1000 times more expensive than iron catalyst.

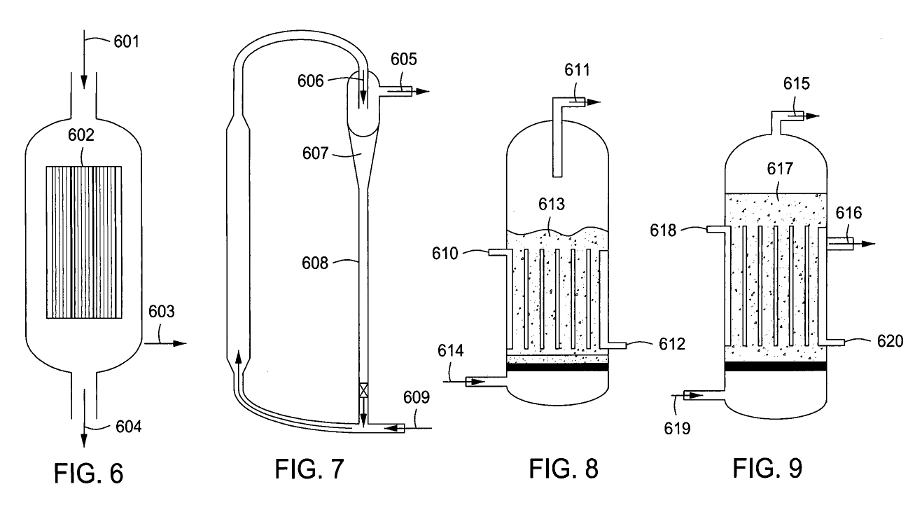

For large-scale commercial FT reactors, heat removal and temperature control are important design features to obtain optimum product selectivity and long catalyst lifetimes. Over the years, basically four FT reactor designs have been used commercially. These are the “multitubular fixed bed”, an example shown in FIG. 6, the “slurry” or the “fluidized bed” (with either fixed or circulating bed) reactor (examples shown in FIGS. 7-9). The fixed bed reactor includes thousands of small tubes with the catalyst as surface-active agent in the tubes. Water surrounds the tubes and regulates the temperature by setting the pressure of evaporation. The slurry reactor is widely used and includes fluid and solid elements, where the catalyst has no particular position, but flows around as small pieces of catalyst together with the reaction components. The slurry and fixed bed reactor are used in LTFT. The fluidized bed reactors are diverse, but characterized by the fluid behavior of the catalyst. The literature of FT contains details of the reactors, and any FT reactors, units, or processes known to those skilled in the art are usable with embodiments disclosed herein. The fluidized bed reactor is used in HTFT. Examples of these four types of reactors are shown in FIGS. 6-9.

FIG. 6 illustrates an exemplary multi-tubular (ARGE) fixed bed. Syngas inlet 601, catalyst tubes 602, gas outlet 603, and wax outlet 604 are shown.

FIG. 7 shows an exemplary circulating (synthol) fluidized bed, including syngas inlet 609, standpipe 608, catalyst 607, hopper 606, and gas outlet 605. FIG. 8 shows an example of a fixed (sasol advanced synthol) fluidized bed, including syngas inlet 614, catalyst bed 613, steam 610, cooling water 612, and gas outlet 611. An example of a fixed slurry bed is depicted in FIG. 9, including syngas inlet 619, slurry bed 617, steam 618, cooling water 620, gas outlet 615, and wax outlet 616.

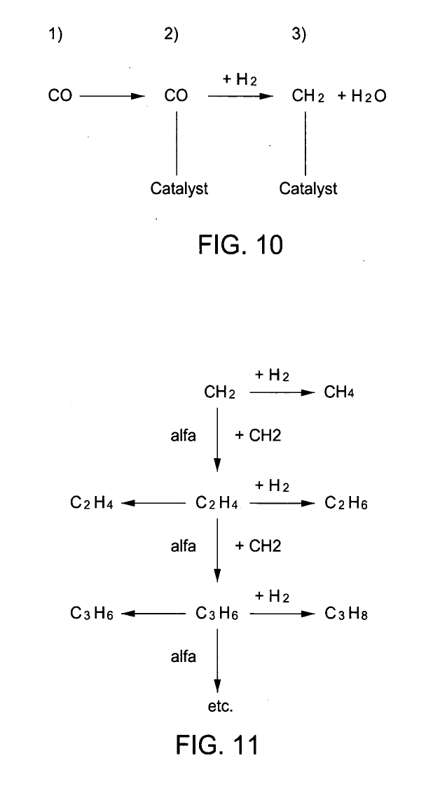

Shown in FIG. 10 is how the chain building process starts (chain initiation), where CO reacts with H₂ to form CH₂, with H₂O as a by-product.

For a theoretical optimal and stoichiometric chain growth, there may be a need for two hydrogen molecules for each CO molecule. This relation is the H₂/CO ratio and differs in the range between 1.7:1 and 3:1.

The FT process produces different olefins and paraffins of different length. The process is basically a chain-building process, where the chain either gains length by adsorbing another CO group, or terminates and leaves the catalyst as either paraffin or olefin. This chain-building process is shown in FIG. 11.

FIG. 11 shows that there are two possibilities; either terminate to a paraffin (right side) or an olefin (arrow to the left), or grow further with the absorption of CO and H₂ as CH₂.

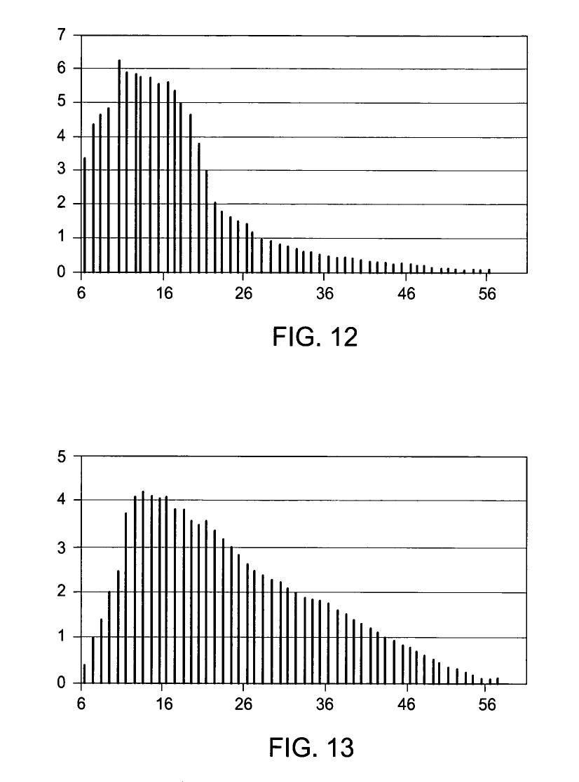

Two examples of product distributions are given in FIGS. 12 and 13, the first with iron catalyst, and the second with cobalt catalyst. The experiments are carried out at the Technical University of Vienna. The reactions take place in a bench scale FT reactor (approximately 250 ml reactor volume). The x-axis indicates the chain length, while the y-axis shows the percentage on weight basis.

The reactions with iron catalyst (see FIG. 13) are conducted with approximately 30 bars and at approximately 280° C. The iron catalyst provides high selectivity in the important interval between C₁₀-C₁₈, which means a high yield of diesel.

The cobalt catalyst provides a higher growth probability, as heavier products are produced. The reaction conditions were approximately 30 bar and approximately 240° C. The heavier and longer hydrocarbons may be easily cracked into desired products.

The probability of chain growth, α, is assumed to be constant, and this assumption fits well with many experiments done with FT synthesis. With a constant probability of chain growth, the mathematical expression of the product distribution is easy to obtain.

In some embodiments, as mentioned above, the FT synthesis 40 includes four FT reactors. However, it is within the scope of alternate embodiments that fewer or more than four FT reactors may be employed in the FT synthesis process 40. The FT synthesis 40 produces FT synthesis product stream 23 and steam 26. The steam 26 may exit the process.

The FT synthesis product stream 23 may be flowed into a product recovery and/or upgrading process 45 to ultimately result in a diesel product stream D, naphtha product stream N, and a carbon-containing tailgas stream 24. In one example, continuing the example mass flow rates as mentioned above in the examples, the diesel product stream D and naphtha product stream N may include a total of approximately 1,206 TPD carbon. In this example, approximately 7,500 barrels per day (“BPD”) of diesel product D is produced, while approximately 3,509 BPD of naphtha product N is produced.

In the FT synthesis 40 and the gasification 5, the capture of carbon dioxide is an inherent step in the production of syngas and FT fuels, minimizing the cost of carbon dioxide separation.

The tailgas 24 may optionally flow into one or more tailgas compressors 50 to produce carbon-containing, compressed tailgas stream 27. Compressed tailgas stream 27 may enter into a TIPS boiler 60, which is described in more detail below.

The third carbon dioxide rich stream 18 exiting the Rectisol or Selexol process 25 may be utilized for temperature control in the TIPS boiler 60. For this purpose, the third carbon dioxide rich stream 18 bypasses the FT process 40 and flows into the TIPS boiler 60 after optionally being compressed via one or more carbon dioxide compressors 55. In some embodiments, compressed carbon dioxide rich stream 28 exits the compressor 55 and enters the TIPS boiler 60.

One or more air separation units (“ASUs”) 80 may produce oxygen from air 31 for delivery to the quench gasifier 5 via oxygen-containing stream 33 and optional delivery to the TIPS boiler 60 via oxygen-containing stream 32. Therefore, the ASU 80 may be efficiently utilized for two purposes—to provide the needed oxygen for operation of the TIPS boiler 60 as well as the oxygen needed in the gasifier(s). The oxygen-containing stream 32 is usable in the TIPS boiler 60 to chill and condense the carbon dioxide.

The TIPS boiler 60 is described in U.S. Pat. Nos. 6,918,253 issued on Jul. 19, 2005 and 6,196,000 issued on Mar. 6, 2001, each patent having the inventor Alexander G. Fassbender, each of which is incorporated by reference herein. The syngas from the gasification process ultimately may be combusted in the TIPS boiler to generate electric power. The TIPS system generally includes an elevated pressure power plant or system that provides for cleanly and efficiently oxidizing or combusting a fuel as follows. The fuel and an oxidant are passed to a reaction chamber, and the fuel is oxidized in the chamber at a pressure that is preferably substantially within a range of from approximately 700 psia to approximately 2000 psia and that is more preferably substantially within a range of from approximately 850 psia to approximately 1276 psia. A coolant may be passed to the reaction chamber in a heat exchange relationship with the fuel and oxidant. The pressure of the reaction chamber may be selected so that it is greater than or equal to a liquid-vapor equilibrium pressure of carbon dioxide at the temperature at which the coolant is passed to the reaction chamber. Products of combustion from the chamber may be passed to a heat exchanger, and water may be condensed from the products of combustion in the heat exchanger at a pressure that is preferably substantially within a range of from approximately 700 psia to approximately 2000 psia and that is more preferably substantially within a range of from approximately 850 psia to approximately 1276 psia. A portion of the condensed water may be recycled to the products of combustion upstream of the heat exchanger. Also, before being passed to the reaction chamber, the coolant may be routed through the heat exchanger in a two-step pressure fashion so that the coolant passes to the heat exchanger at a pressure substantially within a range of from approximately 300 psia to approximately 600 psia and passes to the reaction chamber at a pressure substantially within a range of from approximately 2000 psia to approximately 5000 psia.

In some embodiments, TIPS includes a method of operating a power plant, comprising passing a fuel to a reaction chamber; passing an oxidant to said reaction chamber; oxidizing said fuel in said reaction chamber at a first pressure substantially within a range of from approximately 700 psia to approximately 2000 psia; and passing a coolant to said reaction chamber in a heat exchange relationship with fuel and oxidant. In other embodiments, TIPS includes a method of combusting fossil fuel, comprising passing a fossil fuel into a combustion chamber; passing an oxidant into said combustion chamber; combusting said fossil fuel within said combustion chamber at a first pressure; and passing a coolant having an entry temperature to said combustion chamber in a heat exchange relationship with said combusting fossil fuel; said first pressure being equal to or greater than a liquid-vapor equilibrium pressure of carbon dioxide at said entry temperature of said coolant. In other embodiments, TIPS includes a method of operating a power plant, comprising passing a fuel to a reaction chamber; passing an oxidant to said reaction chamber; oxidizing said fuel in said reaction chamber to create products of oxidation; passing a coolant to said reaction chamber in a heat exchange relationship with said fuel and oxidant; passing said products of oxidation from said reaction chamber to a heat exchanger; and condensing water from said products of oxidation within said heat exchanger at a pressure substantially within a range of from approximately 700 psia to approximately 2000 psia. In yet other embodiments, TIPS includes a method of operating a power plant, comprising passing a fuel to a reaction chamber; passing an oxidant to said reaction chamber; oxidizing said fuel in said reaction chamber to create products of oxidation; passing said products of oxidation from said reaction chamber to a heat exchanger; condensing water from said products of oxidation within said heat exchanger; passing a coolant from a first pump to said heat exchanger at a first pressure; passing said coolant from said heat exchanger to a second pump; and passing said coolant from said second pump to said reaction chamber at a second pressure higher than said first pressure. Other embodiments of TIPS include a method of operating a power plant, comprising passing a fuel to a reaction chamber; passing an oxidant to said reaction chamber; oxidizing said fuel in said reaction chamber to create products of oxidation; passing said products of oxidation from said reaction chamber to a heat exchanger; condensing water from said products of oxidation within said heat exchanger; passing a coolant from a first pump to said heat exchanger at a first pressure; passing said coolant from said heat exchanger to a second pump; and passing said coolant from said second pump to said reaction chamber at a second pressure higher than said first pressure.

Some embodiments of TIPS include an elevated pressure power plant for cleanly and efficiently oxidizing, gasifying or combusting a fuel. The fuel is oxidized or gasified in a reaction chamber at a pressure range from approximately 700 psia to 2000 psia, or from approximately 850 psia to 1276 psia. Products of combustion from the chamber may be passed to a heat exchanger. A portion of the condensed water may be recycled to the products of combustion upstream of the heat exchanger. Also, before being passed to the reaction chamber, the coolant may be routed through the heat exchanger in a two-step pressure fashion.

TIPS embodiments may include a method of operating a power plant, comprising passing a fossil fuel into a combustion chamber; passing an oxidant into said combustion chamber, said oxidant comprising oxygen and carbon dioxide; combusting said fossil fuel within said combustion chamber at a first pressure, said first pressure being substantially within a range of from approximately 700 psia to approximately 2000 psia; and passing a coolant having a heat exchange relationship with said combusting fossil fuel and a heat sink having a first temperature; said first pressure being equal to or greater than a liquid-vapor equilibrium pressure of carbon dioxide at said first temperature of said heat sink; passing products of partial combustion from said combustion chamber to a heat exchanger; condensing water from said products of partial combustion at a second pressure within said heat exchanger, said second pressure being selected so that said water condenses from said products of partial combustion at a temperature above approximately 450 degrees F.; and passing said products of partial combustion to a boiler, gas turbine, combined cycle power plant, and/or chemical synthesis plant.

Flowed into the TIPS-boiler 60 are the carbon dioxide rich stream 28, the carbon-rich tailgas 27, the oxygen stream 32, and boiler feed water (“BFW”) 36. Products from the TIPS boiler 60 are plant power PP, net power NP, and pipeline quality liquid product L. In continuance of the example mass flow rates included herein, the pipeline quality liquid product L includes approximately 1,881 TPD of carbon. In this example, the net power NP produced is approximately 108.5 megawatts (MW), while the plant power PP produced is approximately 135.4 MW.

In between the plant and net power PP and NP products and the TIPS boiler 60 may be a steam turbine and generator 65 for generating power 64 and a condenser 70. A TIPS boiler exit stream 61 exits the TIPS boiler 60 and flows into the steam turbine 65. Upon entering the steam turbine 65 and transferring energy to the turbine, it becomes a stream 62 and it flows to the condenser 70. After condensing in condenser 70, stream 62 becomes liquid stream 63 which is returned to the process as boiler feed water. The turbine and generator 65 provides power 64, which may be split into net power NP and plant power PP.

An oxidant such as pressurized liquid oxygen, for example the pressurized liquid oxygen from the air separation unit 80, may be utilized to chill and condense carbon dioxide on a back end of the TIPS boiler 60. This pressurized liquid oxygen may also be used to reduce a temperature of steam condensation in the steam turbine 65 to increase efficiency of the steam turbine 65.

The air separation unit 80 may provide pressurized liquid oxygen to the Rectisol or Selexol process 25 to cool the solvent, especially when the Rectisol process is used so that the methanol solvent may be properly cooled without the need to provide additional energy to cool the solvent to the required temperature to perform the process. The oxygen may further be used in the TIPS boiler 60 and steam turbine 65, as described in the previous paragraph. Additionally, the oxygen may be used in the quench gasifier 5 after oxygen is warmed up under pressure.

The TIPS boiler 60 may be used for dual purposes, including to produce product (e.g., power) and to capture carbon dioxide.

Because removing the carbon dioxide from the syngas produced from coal or other similar domestic energy sources is part of the capital cost of the plant or system of embodiments (e.g., in gasification 5, Rectisol or Selexol process 25, and FT synthesis 40) and is a byproduct of the co-production of the useful and valuable co-products in embodiments shown and described herein, the cost of carbon dioxide removal is reduced relative to typical coal to liquids processes. The embodiments described herein are capable of removing upwards of approximately 90 percent of the carbon dioxide, and may be capable of removing upwards of approximately 95 percent of the carbon dioxide, reducing greenhouse gas emissions from coal to liquid production.

The United States Environmental Protection Agency (EPA) and states have steadily tightened regulations for allowable amounts of pollutants that can be discharged into the atmosphere, including nitrogen oxides (NOₓ). To meet increasing EPA and state mandates to reduce NOₓ emissions, often more aggressive reduction techniques such as Selective Catalytic Reduction (SCR) must be used by coal-fired power plants for their power block. Policy and regulatory risks associated with the state or EPA requirements of the most advanced NOₓ emission controls for the power block are that SCR regulations might be imposed, proving costly. These risks would be mitigated by having the TIPS technology handle the power block energy production, as disclosed in embodiments.

FIG. 2 shows a roadmap of a process and system of embodiments for coal to liquids co-production and carbon dioxide capture utilizing gasification and Fischer Tropsch (“FT”) with pressurized oxyfuel. Coal, biomass, or other feed F undergoes gasification 105, producing syngas 106 and heat 107. Particulate capture 110 may be performed on syngas 106 to remove mercury and other particulates and produce stream 111. Hydrogen sulfide (H₂S) capture 115 may then be performed on this stream 111 to produce stream 116. Hydrogen sulfide capture 115 may be, for example, via Rectisol or Selexol process and/or sulfur polish as described above in relation to FIG. 1. Of course, although not shown in FIG. 2, conversion to elemental sulfur and/or sulfur polish may also be performed on the hydrogen sulfide captured as shown in described in FIG. 1.

The product stream 116 from the hydrogen sulfide capture 115 may be combined with steam 117 in an FT reactor 120 where FT reactions take place. The FT reactions produce hydrocarbon stream 122, tailgas 121, and heat 123. Hydrocarbon stream 122 may optionally proceed to hydrocarbon cooling and separation 125 to form hydrocarbon products 130 and heat 127. Hydrocarbon products 130 may include, for example, transportation fuel such as diesel and naphtha (which may be liquid fuels).

Tailgas 121 from the FT reactor 120 undergoes pressurization 135, for example in one or more tailgas compressors, and the pressurized tailgas 136 is fed into a high efficiency Rankine cycle power and heat unit 140 (which may be a TIPS boiler or process). Additionally, the heat 107, 123, and 127 is fed into the unit 140.

Air separation and oxygen (O₂) pressurization 165 may be performed to separate nitrogen (N₂) 168 from the oxygen. This pressurized liquid oxygen may serve dual purposes, as it does in the embodiment shown and described herein in relation to FIG. 1. First, it may be utilized in the gasification 105 and subsequent processes via oxygen stream 166. In one embodiment, the liquid oxygen generated from air separation is ultimately utilized in the Rectisol or Selexol process to cool the solvent such as methanol or Selexol solvent to provide effective acid gas separation from the feed stream. As mentioned earlier, refrigeration is required to keep the temperatures low in the Rectisol or Selexol process. Using the liquid oxygen from the air separation and pressurization 165 to cool the solvent eliminates the need for a separate refrigeration system for the Rectisol or Selexol process, and this decreases the refrigeration cost of this process (this use of cold liquid or gaseous oxygen to cool the solvent applies similarly to the embodiment shown and described in relation to FIG. 1 with oxygen stream 33). In one example, air separation may be performed by one or more air separation units, and liquid oxygen may be pressurized by a pump prior to being used to cool the solvent in the Rectisol or Selexol process(es) and/or the produced CO₂ and/or the steam condensing at the back of the Rankin cycle turbine. Pressurization of the liquid oxygen may be accomplished by one or more pumps.

Second, the liquid oxygen from the air separation and oxygen pressurization 165 may be flowed into the Rankine cycle power and heat unit 140 via liquid oxygen stream 167. This oxygen stream 167 may provide needed oxygen to the Rankine cycle power and heat unit 140 (see explanation of advantage of this oxygen in relation to TIPS boiler related to FIG. 1).

Heat 107, 123, and 127 is introduced into the Rankine cycle power and heat unit 140 along with the pressurized tailgas 136 and the liquid oxygen 167. The Rankine cycle power and heat unit 140 generates a carbon dioxide rich product stream 142 and electric power 160. The electric power 160 may be utilized to power the air separation and oxygen pressurization 165, thereby providing power to the air separation and oxygen pressurization 165. Of course, this electric power 160 may also or instead be utilized at other portions of the process and system or may be utilized in a separate process or system.

The product stream 142 may flow into one or more condensing heat exchangers 145 to produce carbon dioxide 147 and hot water 155 (hot clean feed water). The hot water 155 may be reused in the process or in other processes or alternately released into environmental water sources. The recovered water 155 is very clean and pure, thus eliminating the time, energy, and equipment usually required to remove impurities from the water 155. The water 155 may be considered an advantageous co-product of the process.

The separated carbon dioxide 147 may flow to carbon dioxide utilization and/or storage or sequestration 150 (or may be reused), for example, via one or more pipelines. Heat 146 resulting from the condensing heat exchanger 145 may be recycled to the high efficiency Rankine cycle power and heat unit 140 to provide additional heat.

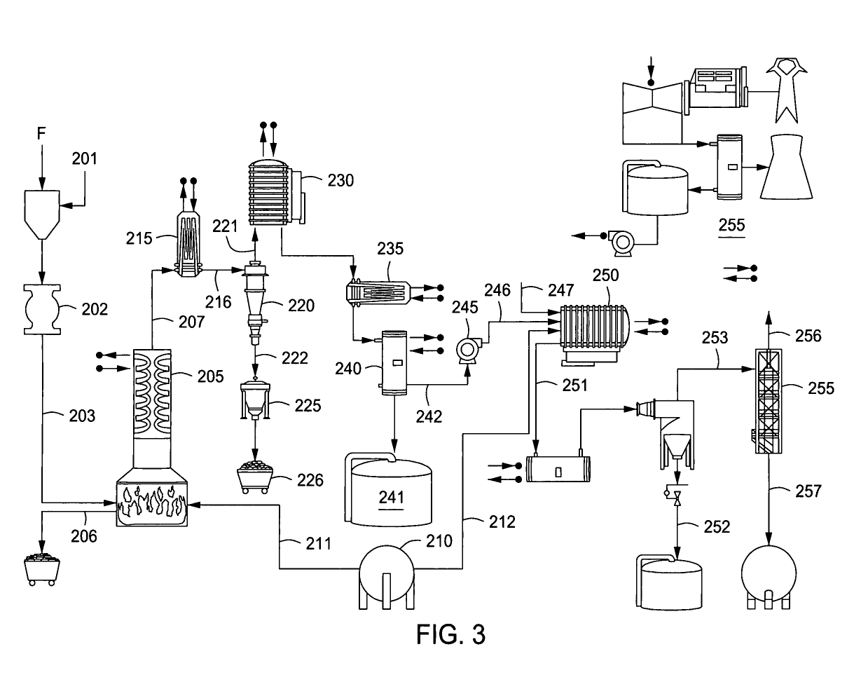

FIG. 3 shows a hybrid polygeneration system and process of embodiments which constitute a Section 526 complaint FT fuels plant and process with pressurized oxy-fuel carbon capture. The feed F (such as coal or other domestic energy source) may optionally be mixed with water 201 and optionally passed through coal feed preparation 202 to form gasifier feed 203. Gasifier feed 203 is then introduced into one or more gasifiers 205, where the one or more gasifiers 205 produce syngas 207 and slag 206 products. One or more air separation units 210 and one or more optional oxygen pressurization units supply liquid oxygen (O₂) via oxygen stream 211 to the gasifier 205 to aid in production of the syngas 207 and slag 206 products.

The syngas 207 is optionally fed into one or more heat exchangers 215, and the product syngas 216 enters gas cleanup 220 (which may include, for example, particulate removal, carbonyl sulfide hydrolysis, water gas shift, mercury removal, and/or Rectisol or Selexol processes, as described herein) to separate into a first stream 221 and a second stream 222. The second stream 222 may continue to a sulfur plant or process 225 (e.g., a Claus plant with tail gas cleanup) for converting the second stream 222 into elemental sulfur 226.

The first stream 221 may continue to one or more slurry FT reactors 230, including heat recovery 235, to recover hydrocarbon product in the form of FT fuel product(s) 241. The remainder of the product exiting the FT reactors 230 and accompanying units 235, 240 is tailgas 242, which enters tailgas pressurization which may include one or more tailgas compressors 245. Compressed tailgas 246 exiting tailgas compressor 245 enters a pressurized oxy-fuel combustor-boiler 250 along with steam 247 and pressurized liquid or gaseous oxygen 212 from the air separation unit 210. The combustor-boiler 250 may include Rankine cycle 255 shown.

Carbon dioxide rich product 251 exiting from pressurized oxy-fuel combustor-boiler 250 is split into a water stream 252 and primarily carbon dioxide stream 253 after condensing. The carbon dioxide stream 253 may enter one or more carbon dioxide distillation columns 255, which remove argon 256 from stream 253 to form the captured carbon dioxide 257.

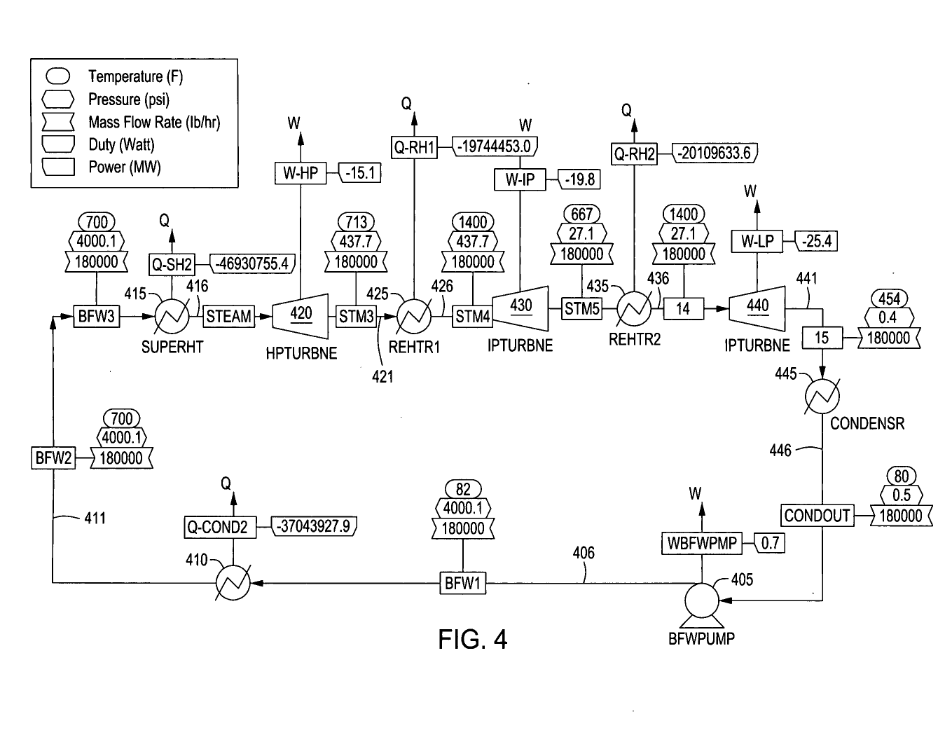

FIG. 4 shows an embodiment of an FT tailgas TIPS plant steam cycle for use with embodiments. One or more boiler feed water pumps 405 increase pressure of a first boiler feed water stream 406, which enters one or more condensing heat exchangers 410. The condensing heat exchanger 410 outputs second boiler feed water stream 411, which then flows into one or more superheaters 415, from which superheated steam 416 then exits. The superheated steam 416 flows into a high power turbine 420.

Steam 421 from the high power turbine 420 is heated by a first reheater 425, from which steam 426 flows into an intermediate power turbine 430. Steam 431 exits from the turbine 430 into a second reheater 435. The second reheater 435 outputs steam 436, which then flows into low power turbine 440. Output steam 441 from the low power turbine 440 is flowed into one or more condensers 445 to form boiler feed water 446.

The temperature, pressure, mass flow rate, duty, and power numbers shown in FIG. 4 are merely exemplary, illustrative, and approximate, and other numbers are contemplated as within the scope of embodiments.

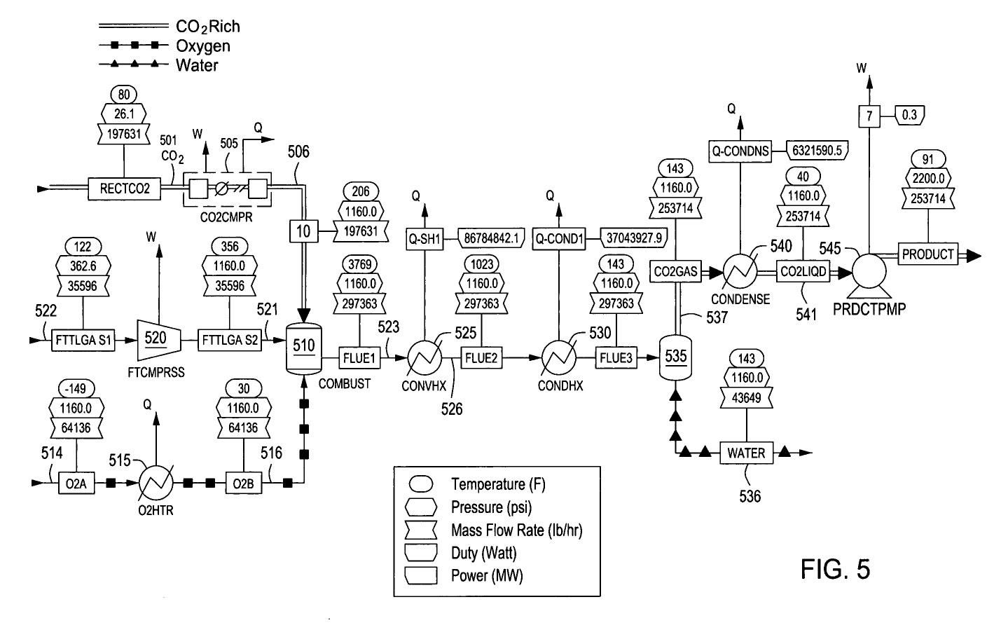

FIG. 5 illustrates an embodiment of an FT tailgas TIPS combustion cycle. Generally, the combustion cycle includes sending a carbon dioxide rich stream 501 to one or more carbon dioxide compressors 505, then sending the compressed carbon dioxide rich stream 506 into one or more combustors 510. A second feed stream into the combustor 510 is an oxygen (O₂) rich stream 516 or oxidant. The oxygen stream 516 may result from oxygen stream 514 being heated by one or more oxygen heaters 515 (and the oxygen may be produced from one or more ASUs). A third feed stream into the combustor 510 is FT tailgas 521. FT tailgas 521 is produced when FT tailgas 522 enters and exits from one or more FT compressors 520.

After combustion in the combustor 510, flue gas 523 exits from the combustor 510 and then enters one or more convection heat exchangers 525. Flue gas 526 exits from the one or more convection heat exchangers 525 into one or more condensing heat exchangers 530. Flue gas 531 product resulting from the one or more condensing heat exchangers 530 enters one or more condensing separators 535, where water 536 in the flue gas 531 is separated from carbon dioxide gas 537. The water 536 may be one of the co-products. Carbon dioxide gas 537 may be condensed by one or more condensers 540 to form carbon dioxide liquid product 541. Carbon dioxide liquid product 541 may be pumped to its destination via one or more product pumps 545.

The temperature, pressure, mass flow rate, duty, and power numbers shown in FIG. 5 are merely exemplary, illustrative, and approximate, and other numbers are contemplated as within the scope of embodiments.

Carbon capture and storage, as described in above embodiments, may enable coal to liquids plants and processes to emit less carbon dioxide than oil-based or petroleum-based fuels. The above embodiments further reduce the cost and increase the efficiency of carbon capture and storage in a coal to liquids plant and process. Cost is reduced and efficiency is increased by, for example, reusing the produced water, using the produced heat and power to operate the coal to liquids plant, and/or using the oxygen-producing unit already on site.

The above embodiments produce minimal or no acid gas or toxic emissions, may capture greater than approximately 90 percent of the carbon in the coal, require few process steps thereby providing simplicity, allow flexibility in fuel feed source, provide efficiency in use of capital, feed fuel use, and production of co-products from this capital and feed fuel, and seamlessly transition to sequestration, storage, or reuse of captured carbon dioxide.

The pressurized oxy-fuel system and process of embodiments advantageously condenses exhaust water and carbon dioxide, includes a small, low energy carbon dioxide purification train and recovers pressurized liquid carbon dioxide, recovers the latent heat of vaporization of water, and the closed system condenses mercury into a small liquid stream.

Embodiments shown and described herein provide higher pressure than traditional coal-to-liquids units for lower cost due to approximately nine to approximately thirty times greater overall heat transfer coefficient to boiler tubes, the condensing heat exchanger recovering latent heat, particles, and acid gases, the pressurization and vessels constituting a small cost compared to boiler tube savings, and the carbon dioxide product recovery train using simple low energy processes. In embodiments, captured and condensed carbon dioxide is ready for transport and sequestration (or other use) according to required government specifications and acid gases, water, inert gases, and total pressure meet tight pipeline specifications for carbon dioxide transport.

Furthermore, embodiments provide a graceful transition from catch and release of carbon dioxide to capture and sequester of carbon dioxide. In the process and system of embodiments, zero or near zero toxic emission and very high carbon dioxide capture are intrinsic in other process steps for forming the useful co-products, and the Rankine cycle of some embodiments is unaffected by the fate of the carbon dioxide. Additionally, pressurized oxy-fuel plants may require no process flow changes to shift to a capture and sequester mode from a capture and release mode.

Coal to liquids facilities are conventionally thought to be large units built on-site to a custom design, making the major risk factor the large capital cost associated with these plants. Additional risk lies in the conventional coal to liquids facilities because of performance risks associated with the technology when these large units are custom built. To reduce cost and performance risk, embodiments may develop a production base that may mass manufacture a limited number of designs and steadily improve these designs.

Above embodiments also provide for efficient and effective carbon capture to prevent release of the carbon contained in the tailgas entering the power block from being released to the atmosphere.

Finally, embodiments shown and described herein provide faster, less expensive, smaller, and more efficient systems and processes with less use of chemicals than previous coal to liquids with co-production and carbon capture options.

While the foregoing is directed to embodiments of the present invention, other and further embodiments of the invention may be devised without departing from the basic scope thereof, and the scope thereof is determined by the claims that follow.

1. A method of co-producing one or more liquid fuel or chemical products and an electrical power product using a carbon-containing feed fuel, comprising:
providing an air separation unit to separate oxygen from air;
gasifying the feed fuel with the separated oxygen to produce a syngas;
removing hydrogen sulfide from the syngas using a Rectisol or Selexol process, thereby forming a Rectisol or Selexol product stream;
performing Fischer-Tropsch synthesis on the Rectisol or Selexol product stream to produce the one or more liquid fuel or chemical products;
separating the produced fuels or chemical products from a tailgas;
combusting the tailgas using pressurized oxyfuel combustion to form the electrical power product; and
capturing pressurized carbon dioxide from the products of the tailgas combustion.

2. The method of claim 1, further comprising using a condensation step to remove condensable components from the syngas.

3. The method of claim 1, further comprising using the oxygen from the air separation unit in the Rectisol or Selexol process to regulate a temperature of a solvent.

4. The method of claim 3, further comprising using at least a portion of the oxygen from the air separation unit for combusting the tailgas using pressurized oxyfuel combustion.

5. The method of claim 1, wherein combusting the tailgas using pressurized oxyfuel combustion comprises:
passing the tailgas to a reaction chamber;
passing the oxygen to the reaction chamber;
oxidizing the tailgas in the reaction chamber at a first pressure substantially within a range of from approximately 700 psia to approximately 2000 psia; and
passing a coolant to the reaction chamber in a heat exchange relationship with the tailgas and oxygen.

6. The method of claim 1, further comprising separating carbon dioxide from the tailgas to provide a pipeline quality liquid product.

7. The method of claim 6, further comprising separating carbon dioxide from the syngas using the Rectisol or Selexol process.

8. The method of claim 7, further comprising using the carbon dioxide from the Rectisol or Selexol process for temperature control when combusting the tailgas using pressurized oxyfuel combustion.

9. The method of claim 1, further comprising converting the hydrogen sulfide to elemental sulfur using one or more Claus plants.

10. The method of claim 1, wherein the feed fuel comprises coal.

11. The method of claim 1, wherein the feed fuel comprises one or more of coal, biofuel, lignite, biomass, orimulsion, refuse derived fuels, natural gas, liquid methanol, or bitumen.

12. The method of claim 1, wherein the feed fuel is solid.

13. The method of claim 1, further comprising using a first portion of the carbon dioxide resulting from the Rectisol or Selexol process for temperature control when combusting the tailgas using pressurized oxyfuel combustion.

14. The method of claim 13, further comprising recycling a second portion of the carbon dioxide resulting from the Rectisol or Selexol process into one or more gasifiers for gasifying the feed fuel to produce a syngas.

15. The method of claim 14, wherein the Rectisol or Selexol product stream comprises a third portion of the carbon dioxide resulting from the Rectisol or Selexol process.

16. The method of claim 1, wherein capturing carbon dioxide is accomplished in the Rectisol or Selexol process, the Fischer-Tropsch synthesis, and when combusting the tailgas using pressurized oxyfuel combustion to form the electrical power product.

17. A method of forming one or more liquid co-products from a carbon-containing feed fuel, comprising:
separating oxygen from air using an air separation unit to form liquid oxygen;
pressurizing the liquid oxygen;
gasifying the feed fuel to form a syngas;
performing a Rectisol or Selexol process on the syngas using a solvent to remove acid gas from the syngas, thereby forming a carbon dioxide rich product stream; and
using at least a portion of the liquid oxygen in the Rectisol or Selexol process for temperature control of the solvent.

18. The method of claim 17, further comprising:
introducing the carbon dioxide rich product stream into a Fischer-Tropsch process to form the one or more liquid co-products; and
separating the one or more liquid co-products from a tailgas.

19. The method of claim 18, wherein the one or more liquid co-products comprise diesel and naphtha.

20. The method of claim 18, further comprising combusting the tailgas in a pressurized boiler using pressurized oxygen from the air separation unit, thereby forming electrical power and capturing carbon dioxide.

21. The method of claim 20, wherein the pressurized oxygen is used in the boiler to condense the carbon dioxide for capturing the carbon dioxide from the boiler.

22. The method of claim 21, wherein the pressurized liquid or gaseous oxygen has a heat exchange relationship with the low pressure steam exiting a steam turbine which is utilized for producing the electrical power, thereby reducing the pressure of steam condensation at the exit of the steam turbine.

23. The method of claim 20, further comprising using at least a portion of the electrical power product to provide power to the air separation unit.

24. A method of producing one or more liquid fuel products and capturing carbon dioxide from a carbon-containing feed fuel, comprising:
performing a gasification of the feed fuel, thereby producing a syngas;
cleaning the syngas by removing gases and contaminants;
passing the cleaned syngas into a Fischer-Tropsch reactor to form the one or more liquid fuel products and separate a carbon dioxide rich tailgas from the syngas;
passing the carbon dioxide rich tailgas into a combustion chamber at a first pressure substantially within a range of approximately 700 psia to approximately 2000 psia;
passing an oxidant into the combustion chamber at a first pressure substantially within a range of approximately 700 psia to approximately 2000 psia;
oxidizing the tailgas in the combustion chamber at a first pressure substantially within a range of approximately 700 psia to approximately 2000 psia;
passing a coolant into the combustion chamber in a heat exchange relationship with the tailgas and oxidant; and
capturing the carbon dioxide from the carbon dioxide rich tailgas.

25. The method of claim 24, wherein the one or more liquid fuel products comprise naphtha, wax, and diesel fuel.

26. The method of claim 25, further comprising producing electric power using steam produced by using heat from the combustion chamber.

27. The method of claim 24, further comprising the use of pressurizing liquid or gaseous oxygen to condense the captured carbon dioxide.

28. The method of claim 24, further comprising:
passing the captured carbon dioxide into one or more condensing heat exchangers; and
producing a liquid carbon dioxide product stream and a water product stream from the one or more condensing heat exchangers.
